(19) United States
(12) Patent Application Publication
(10) Pub. No.: US 2015/0271876 A1
(43) Pub. Date: Sep. 24, 2015

(54) SYSTEMS AND METHODS FOR WARMING PLANTS

(71) Applicant: Elwha LLC, Bellevue, WA (US)

(72) Inventors: Jeffrey A. Bowers, Bellevue, WA (US); Russell J. Hannigan, Sammamish, WA (US); Roderick A. Hyde, Redmond, WA (US); Jordin T. Kare, Seattle, WA (US); Nathan Kundtz, Kirkland, WA (US); Nathan P. Myhrvold, Bellevue, WA (US); John B. Pendry, Cobham (GB); David R. Smith, Durham, NC (US); Clarence T. Tegreene, Mercer Island, WA (US); David B. Tuckerman, Lafayette, CA (US); Charles Whitmer, North Bend, WA (US); Lowell L. Wood, JR., Bellevue, WA (US)

(21) Appl. No.: 14/223,682

(22) Filed: Mar. 24, 2014

(51) Int. Cl. H05B 6/64; H05B 1/02

(52) U.S. Cl. CPC H05B 6/645; H05B 1/0227

(57) ABSTRACT

A plant warming system includes a sensor configured to acquire temperature data representative of a temperature of a plant, a heating system including an antenna configured to direct microwaves toward the plant, and a control system configured to control operation of the heating system based on the temperature data.

### BACKGROUND

Agricultural growing operations operate efficiently when, among other things, plants are provided with an optimal growing environment to allow the plant to properly germinate and grow. The local temperatures around the plants may affect the amount of growth of the plants, as well as the amount and quality of any crop (including, but not limited to, grains, fruit, vegetables, and flowers) produced.

### SUMMARY

One embodiment relates to a plant warming system, comprising a sensor configured to acquire temperature data representative of a temperature of a plant; a heating system including an antenna configured to direct microwaves toward the plant; and a control system configured to control operation of the heating system based on the temperature data.

One embodiment relates to a system for controlling the temperature of plants, comprising a control circuit configured to receive temperature data representative of a plurality of plants; and control operation of an antenna to selectively direct heat energy toward a portion of the plurality of plants based on the temperature data.

Another embodiment relates to a method of warming a plurality of plants, comprising receiving temperature data representative of the plurality of plants; and directing microwaves toward a portion of the plurality of plants based on the temperature data.

Another embodiment relates to a method of controlling the temperature of plants, comprising receiving temperature data related to temperature of a plurality of plants; and selectively warming a portion of the plurality of plants based on the temperature data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of a plant warming system according to one embodiment.

FIG. 2 is a perspective view of a planting area with a plant warming system according to one embodiment.

FIG. 3 is a block diagram of the plant warming system of FIG. 2 according to one embodiment.

FIG. 4 is a perspective view of a heating system usable with a plant warming system according to one embodiment.

FIG. 5 is a perspective view of a planting area with plant warming systems provided on multiple towers according to another embodiment.

FIG. 6 is a perspective view of a planting area with a plant warming system provided on a satellite according to another embodiment.

FIG. 7 is a perspective view of a planting area with a plant warming system on a mobile device according to another embodiment.

FIG. 8 is a flow diagram of a method of warming plants according to another embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Temperatures may vary from plant to plant and between locations within a planting area. Temperatures vary due to a variety of reasons including microclimates. Further, unpredictable weather may destroy a plant or an entire crop if the temperature is too cold. Plants may also require particular temperatures during certain stages of growth, like germination. Therefore, it may be desirable to control the local temperatures around the plants to protect the plants from undesirable temperature levels and provide optimal growing environments. This may further allow the agricultural growing operation to gain a head start on crop growing by planting before the temperature is adequate and adjusting the local plant temperatures accordingly.

As such, various embodiments disclosed herein relate to altering the temperature around plants according to optimal plant temperatures and surrounding environmental temperatures. For example, the temperature of a plant may be acquired by a temperature sensor. If the temperature is lower than a desired plant temperature, a heating system (such as an antenna and a microwave source) may direct heat toward the plant to warm the area surrounding the plant and/or the plant itself. The heating system may additionally base the amount or intensity of delivered heat on the local measured temperature (or temperature data) compared to a target temperature.

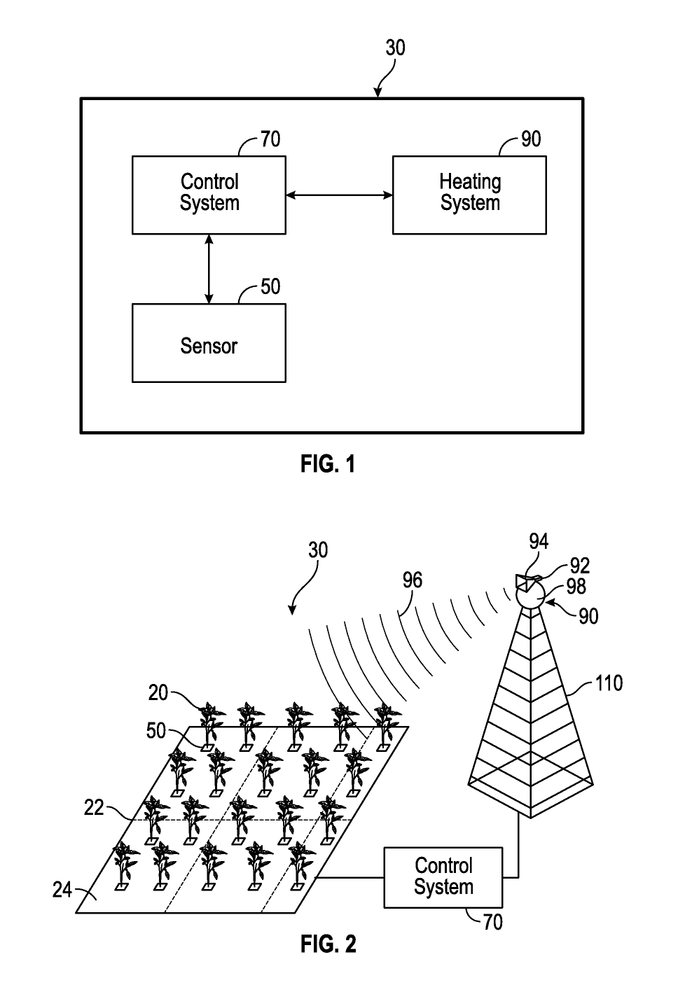

Referring now to FIGS. 1-2, plant warming system 30 is shown according to one embodiment, and includes sensor 50, control system 70, and heating system 90. Sensor 50 acquires temperature data regarding the temperature of a plant, a selected part of the plant (e.g., fruit, seed pod) or the area surrounding a plant (e.g., underlying soil). Sensor 50 transmits the temperature data to control system 70. Based on the temperature data, control system 70 determines if and how much the plant should be heated (e.g. to maintain the temperature at or above a desired or target temperature) and control operation of heating system 90 accordingly. Control system 70 controls the direction, the intensity, and the duration of emitted energy provided by heating system 90.

Plant 20 may be isolated or planted with at least one other plant within planting area 22 in an agricultural growing operation. Planting area 22 may be any location capable of growing plants, such as a field (as shown in FIG. 2), an orchard, a greenhouse, etc. Plant warming system 30 may be used to warm or heat individual plants 20, selected parts of individual plants, a zone 24 (or a corresponding portion of the plurality of plants) within planting area 22, or the entirety of planting area 22. For example, plant warming system 30 may warm individual plants 20 on a plant-by-plant basis (e.g., according to plant-specific needs or target temperatures). An entire plant may be warmed, or a specific part of a plant may be warmed, such as the fruit. By warming plants 20, plant warming system 30 may increase the growth of plants 20, increase the crop yield, and/or protect or improve the health of plants 20 (by preventing plants 20 from freezing, or protecting plants 20 from cold temperatures or frost). A portion of the plurality of plants 20 may refer to a certain or particular subset of the plurality of plants 20. A part of the plant 20 may refer to a subpart of an individual plant, such as a fruit.

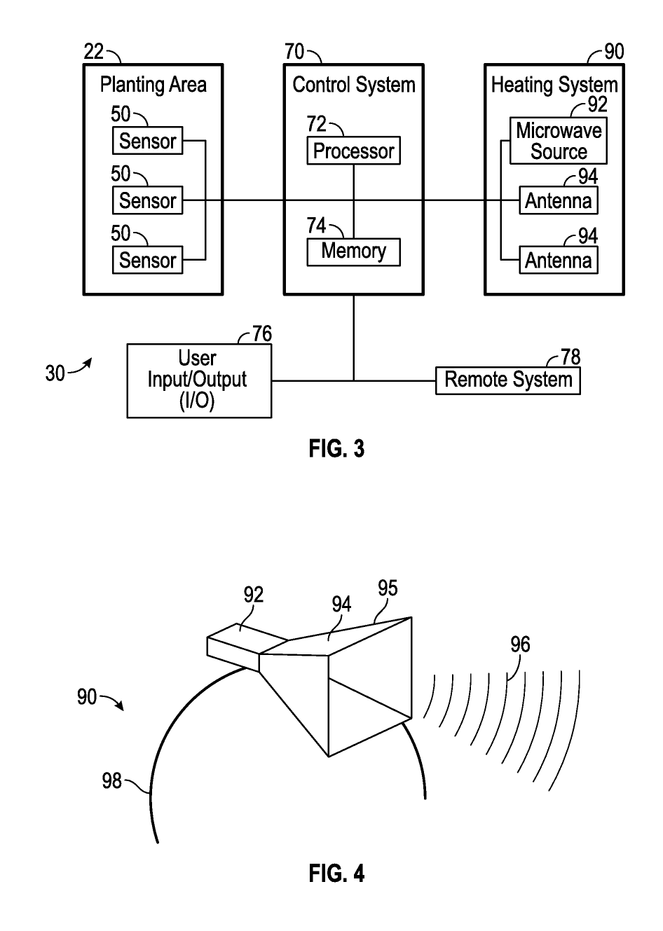

According to one embodiment and as shown in FIGS. 2 and 3, sensor 50 acquires temperature data regarding at least one temperature within planting area 22 and provides the temperature data to control system 70. Control system 70 controls the operation of heating system 90 to warm planting area 22 based on the temperature data. If plant 20 should be heated, control system 70 controls heating system 90 to warm plant 22 according to the amount, intensity, and duration of heating required.

Sensor 50 may be any type of temperature sensor or thermometer capable of detecting or sensing plant temperature or air temperature, such as a thermocouple (locally positioned near plant 20, as shown in FIG. 2), an infrared sensor, or a sensor using microwave imaging thermometry. An infrared sensor, such as a long-wave infrared (LWIR) sensor, may be locally or remotely positioned, depending on the characteristics of the sensor. In some embodiments, a remotely positioned imaging infrared sensor (e.g., using infrared optics and a pixelated array) may be used. A microwave thermometer may optionally be positioned adjacent to plants 20 or remotely positioned. For example, sensor 50 may be remotely positioned with heating system 90. Alternatively or additionally, sensor 50 may include a plate (as shown in FIG. 2) that acts as a temperature sensor and may be heated as plant 20 is heated. The plate may be positioned near plant 20 and provide temperature feedback and indicate to control system 70 a temperature of plant 20. Alternatively or additionally, the plate may be part of heating system 90 and used to warm plants 20. Sensor 50 may directly sense or acquire the temperature of plant 20 or may sense or acquire the temperature of the air near plant 20. Sensor 50 may sense or acquire data which is indirectly representative of the temperature of plant 20, for example, such indirect data can comprise the presence of ice on plant 20. Sensor 50 may provide one initial temperature reading, continuous temperature readings, or intermittent (e.g., at regular intervals, or a specified schedule) temperature readings to provide temperature data to control system 70 in order to indicate whether or not heating system 90 should be activated and how much plant 20 should be heated. Sensor 50 may acquire temperature data for plant 20 or zone 24 based on previous values of the temperature data; for instance, colder plants may be re-sensed more frequently than warmer ones, or plants with temperatures near a threshold temperature may be re-sensed more frequently. Sensor 50 may acquire temperature data for a plurality of plants 20 in a particular order based on a criteria. The criteria may include greatest expected economic gain (e.g., potential crop yield, growth, or value) or which plant 20 will provide the greatest net economic payoff or gain (e.g., the amount of time or energy required to warm plant 20 versus net yield). The prioritization may also be based on an optimization between the potential net yield of plant 20 compared to the distance between the location of plant 20 and heating system 90 (also accounting for the required time and energy). Once sensor 50 has acquired the temperature data of plant 20, sensor 50 may use wired or wireless technology to communicate the temperature data to control system 70. The acquired temperature data may indicate to control system 70 how to control heating system 90 to deliver energy to plant 20.

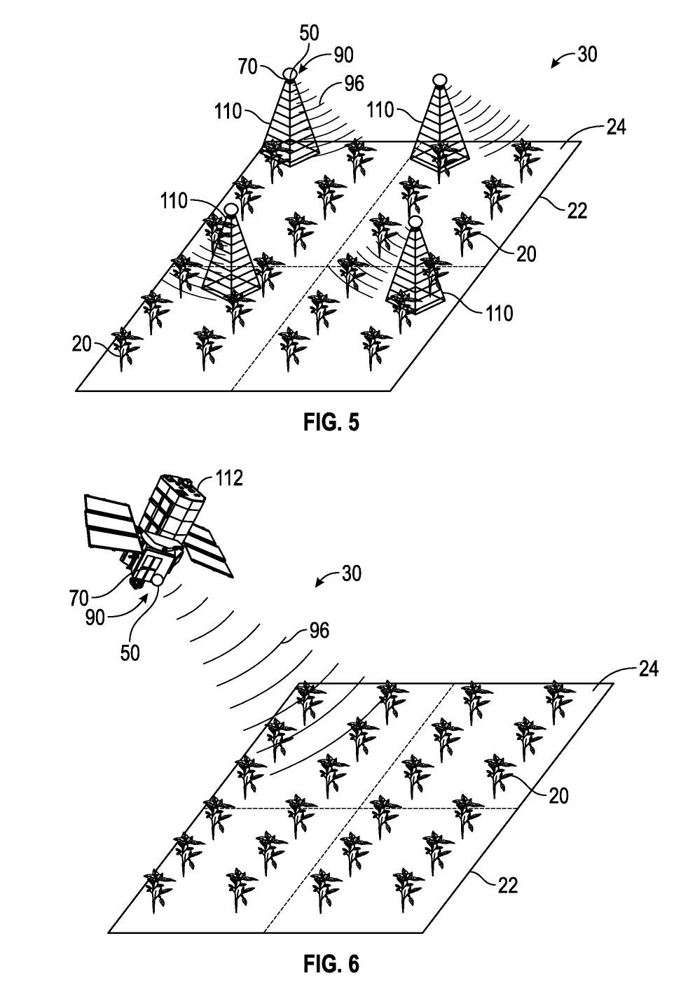

According to one embodiment, temperature sensor 50 may be locally positioned near plant 20 and used to sense or acquire temperature data. For example, each plant 20 (as shown in FIG. 2) or zone 24 within planting area 22 may have designated sensor 50. Multiple sensors 50 may be used to acquire temperature data for multiple plants 20 or zones 24 at the same time. Alternatively or additionally, as shown in FIGS. 5-7, sensor 50 may be located with or adjacent to heating system 90, and one sensor may be used to acquire temperature data for plants 20, zones 24, or planting area 22.

In one embodiment, sensor 50 may provide temperature data to control system 70 on a substantially continuous basis. Alternatively, sensor 50 may provide an initial and/or intermittent temperature readings and control system 70 will control heating system 90 accordingly in order to warm plant 20.

Heating system 90 may be used to heat or warm plant 20, planting area 22, and/or zone 24. Heating system 90 may include a heat energy source 92 and antenna 94 to direct the heat energy. Antenna 94 may be used to direct the heat toward plant 20, according to control system 70. Plant 20 (or parts of plant 20 or portions of planting area 22) may be “beamed” or pulsed with the heat energy to be warmed. The heat energy may sequentially warm specific plants 20, fruit, or zones.

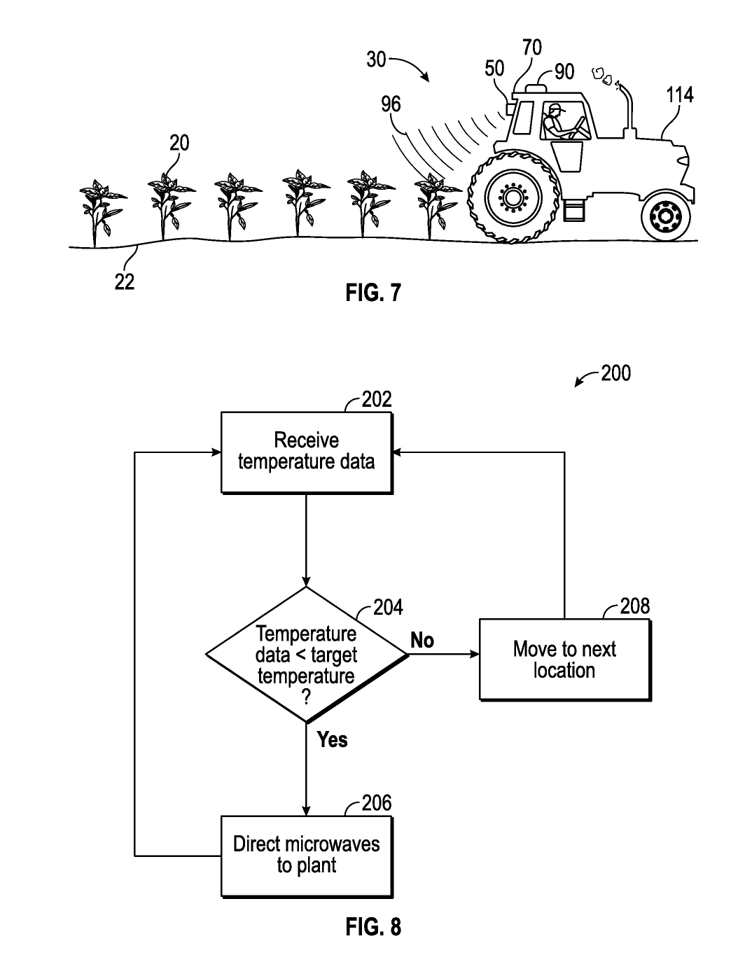

As shown in FIG. 2, heating system 90 may be located remotely. Alternatively, heating system 90 can be located locally and be centrally positioned within a planting area. For example, heating system 90 may be located on tower 110 to reach individual plants 20, zones 24, or entire planting area 22. Microwave source 92 may emit microwaves 96 through antenna 94, located on the top of tower 110, to plants 20 within planting area 22. Alternatively, heating system 90 may be located on multiple towers 110 located throughout planting area 22 (as shown in FIG. 5), on satellite 112 (as shown in FIG. 6), on mobile device 114 (as shown in FIG. 7), or any other device that may permit heating energy to be directed toward plants 20.

Referring to FIG. 4, heating system 90 is shown in greater detail. Heating system 90 is configured to “steerably beam” and direct heat energy towards individual plant 20, zone 24, or plant area 22. The heat energy may be in the form of microwaves from microwave source 92. Microwave source 92 may be positioned at the base or narrow portion of antenna 94. Microwave source 92 and/or antenna 94 can control the characteristics of emitted microwaves 96 in order to directionally emit microwaves 96 over a distance. For example, the frequency, phase, focus, spatial beam profile, intensity, and aiming distance may be altered. The frequency of microwaves 96 may be optimized based the degree of water absorptivity or focusability of one or more plants, cost of components, or on Federal Communications Commission (FCC) wavelength restrictions. For example, a frequency of approximately 2.4 GHz may be used for high water absorptivity, or relatively high microwave frequencies may be used to increase the degree of focusability. Antenna 94 may be sized, shaped, and tuned accordingly to properly focus microwaves 96 toward plant 20 or another desired location.

Antenna 94 may be any type of antenna capable of emitting heat energy. The heat source may be any type of heat-emitting source, such as microwave source 92, and may emit any type of heat energy, such as microwaves 96 or lasers (e.g., to provide very focused and directional heat energy). For example, as shown in FIGS. 2 and 3, microwave source 92 may be used to emit heat, in the form of microwaves 96, from antenna 94.

Antenna 94 may be, for example, a phased array antenna, or a metamaterial antenna, and may be used to efficiently emit microwaves. In an embodiment, a metamaterial antenna can utilize metamaterial surface antenna technology as developed by Kymeta Corporation. Although any type of heat energy-emitting antenna may be used (such as a dipole antenna), horn antenna 95 is shown in FIG. 4. Although a pyramidal horn is shown in FIG. 4, it may be appreciated that a variety of different antennas may be used according to the desired microwave characteristics.

In order to direct microwaves 96 to a desired location, antenna 94 may mechanically or electronically steer the microwaves to the desired location. Microwaves 96 may be physically steered or translated by positioning antenna 94 on motorized platform 98 (e.g., a positioning member) and pivoting, moving, and/or rotating antenna 94 according to the desired direction. Control system 70 may direct heating system 90 toward plant 20, zone 24, or plant area 22. Alternatively or additionally, microwaves 96 may be steered with a waveguide.

In one embodiment, the waves (such as microwaves 96) from antenna 94 are electronically steered by using a phased array or a metamaterial antenna. Beam steering may be utilized by switching which antenna is emitting microwaves and/or changing relative phases of the microwaves to direct the overall heat energy. For example, a patch antenna may be used to electronically steer and direct the heat energy with a series of smaller antennas by altering the frequencies and phases of the emitted heat energy in each antenna.

Control system 70 is used to control the heating of plants 20 (or planting area 22 or zone 24). Control system 70 receives data from sensor 50, and directs heating system 90 according to the temperature data from sensor 50 and, for example, the target temperature. Control system 70 may direct heating system 90 to emit heat energy or microwaves 96 from microwave source 92 through antenna 94 based on a comparison of the temperature data and the target temperature. In some embodiments, heat energy is provided at a constant rate as long as the temperature data is less than the target temperature. In other embodiments, the amount of heat energy is based on the magnitude of the difference between the target temperature and the temperature data, e.g., is proportional to the difference. Microwaves 96 will be absorbed by plant 20, thus heating or warming plant 20 and/or the surrounding area. Control system 70 may further communicate to antenna 94 additional information, such as where to direct microwaves 96 in order to accurately target and warm plant 20.

Control system 70 (e.g., a control circuit) operates according to feedback from sensor 50 and controls heating system 90 according to the temperature data from sensor 50. In some embodiments, control system 70 acquires and uses data on the delivery of microwaves to the target plant or its vicinity; for example, such data can be generated by using a remote microwave sensor to measure microwave reflections from the target, or by using microwave sensors positioned near the target to measure incident microwave energy. For example, if the acquired temperature is already in the desired temperature range of plant 20 (or after heating system 90 has already warmed plant 20), control system 70 may obtain temperature data from a different plant and/or adjust heating system 90 accordingly. If the acquired temperature is less than a desired or target temperature of plant 20, control system 70 may activate and control heating system 90 to warm plant 20 with heat energy. Optionally, control system 70 may obtain temperature data for a plurality of plants 20 from sensor 50, and sequentially control heating system 90 to direct heat energy only toward the portions (i.e., subset) of plants 20 that need heat energy based on the temperature data. Control system 70 may control heating of a portion (or zone) of plants based on a representative temperature of the portion of plants, such as the mean temperature of the portion, the minimum temperature, the median temperature, etc.

Control system 70 may direct heating system 90 to heat plant 20 continuously as sensor 50 continuously provides temperature data to control system 70. Once the temperature data reaches at least the target temperature, control system 70 may direct heating system 90 to stop emitting heat energy toward plant 20. Alternatively, control system 70 may control heating system 90 to provide a set amount of heat energy to be delivered, a set intensity of emitted heat energy, and/or a set duration of emitting heat energy based on the difference between the detected temperature and the target temperature. Alternatively, control system 70 may use time averaging based on the difference between detected and target temperatures in order direct heating system 90 to sufficiently warm plant 20 (e.g., while plant warming system 30 is directed toward a different plant). Alternatively, control system 70 can control the operation of heating system 90 in order to emit heat energy for a set amount of time if the temperature data is less than the target data. Alternatively, control system 70 can control the operation of heating system 90 in order to emit heat energy until a specified rise in temperature is achieved.

Control system 70 may use wired or wireless technology to communicate with heating system 90. Control system 70 may communicate a variety of information to heating system 90. For example, control system 70 may indicate to heating system 90 where to direct the heat from heating system 90, a duration for which to emit heat, or an intensity at which to emit heat.

Referring to FIG. 3, a block diagram of plant warming system 30 is shown. System 30 may be configured to warm plants 20 (as shown in FIG. 2) according to the temperatures of plants 20. Plant warming system 30 may be a feedback system configured to respond to an acquired plant temperature. Plant warming system 30 may include temperature sensor 50, control system 70, and heating system 90. Sensor 50 is configured to detect or acquire the temperature of plant 20. Control system 70 receives the temperature data from sensor 50 and controls heating system 90 accordingly. In one embodiment, control system 70 compares the temperature data detected by sensor 50 to a desired or target temperature to control operation of heating system 90. If activated, heating system 90 will subsequently direct heat energy toward plant 20. Plant 20 will absorb the energy, thereby increasing the plant temperature.

Control system 70 includes a variety of different components to process and analyze the temperature data from sensor 50. For example, control system 70 can include central processing unit (CPU) or processor 72 and memory 74. Processor 72 may be implemented as a general-purpose processor, an application specific integrated circuit (ASIC), one or more field programmable gate arrays (FPGAs), a digital-signal-processor (DSP), a group of processing components, or other suitable electronic processing components. Memory 74 is one or more devices (e.g., RAM, ROM, Flash Memory, hard disk storage, etc.) for storing data and/or computer code for facilitating the various processes described herein. Memory 74 may be or include non-transient volatile memory or non-volatile memory. Memory 74 may include database components, object code components, script components, or any other type of information structure for supporting the various activities and information structures described herein. Memory 74 may be communicably connected to processor 72 and provide computer code or instructions to processor 72 for executing the processes described herein.

Memory 74 may store information such as the target temperature, a heating algorithm, and/or past temperatures. The heating algorithm may, for example, adjust a target temperature according to the time of year, stage of development, or specific temperature needs of each plant 20, zone 24, or planting area 22. Control system 70 may connect directly or indirectly to user input/output (I/O) device 76 to display pertinent information, allow a user to control plant warming system 30, and/or allow the user to adjust the target temperature. Control system 70 may connect with remote system 78. Remote system 78 may be used to receive information or data from an external source, such as a weather report. Remote system 78 may additionally send information externally.

Control system 70 may use a variety of different methods to control which plant 20 or zone 24 is warmed. For example, control system 70 may use an open-loop program (e.g., similar to a raster scan), in which warming is based on the current state or temperature of the plants. The control system 70 may direct sensor 50 to take temperature measurements of plants 20 (or areas surrounding plants 20) throughout plant area 22 and warm plants 20 accordingly. According to another embodiment, control system 70 may use a closed loop, such as a feedback system with sensor 50. For example, control system 70 may control heating system 90 to warm plant 20 until the temperature reaches a desired temperature.

In some embodiments, control system 70 determines which plant 20 or zone 24 may be most beneficial to warm. For example, plants 20 or zones 24 may be prioritized into a particular order according to a criteria. The prioritization may be based on one factor or multiple factors, weighted according to importance. For example, the criteria may include which plant 20 needs energy the most (e.g., which plant is coldest or which may have the greatest expected economic gain (e.g., potential crop yield, growth, or value) or which plant 20 will provide the greatest net economic payoff or gain (e.g., the amount of time or energy required to warm plant 20 versus net yield). The criteria may include the duration or the amount of heating needed for plant 20. The prioritization may also be based on an optimization between the potential net yield of plant 20 compared to the distance between the location of plant 20 and heating system 90 (also accounting for the required time and energy). According to the prioritization, plants 20 or zones 24 may be warmed sequentially in order.

Referring to FIG. 5, there is shown an embodiment in which multiple towers 110 with heating system 90 are located throughout planting area 22. Multiple towers 110 within planting area 22 may provide plant 20 or zone 24 with a more localized source of microwaves 96 compared using, e.g., to one tower 110 for entire planting area 22. Since microwaves 96 are not required to travel as far, and are therefore less spread out at the absorbing end (i.e. plant 20), less power may be required to heat plant 20, plant 20 may be heated to a higher temperature, and microwaves 96 will be more directed and focused to a desired location. Each tower 110 may heat one designated plant 20, multiple plants 20, zone 24 (as shown in FIG. 6), or a general region of plant area 22. Towers 110 may work in conjunction with nearby towers to efficiently warm plant(s) 20, zone(s) 24, or plant area 22.

As shown in FIGS. 5-7, sensor 50 may be located with heating system 90 and may acquire the plant temperatures remotely. For example, sensor 50 may use infrared (IR) technology, such as IR imaging or IR thermometry, to precisely determine the temperature of particular areas or plants 20. In one embodiment, control system 70 may be located with sensor 50 and heating system 90.

Referring to FIG. 6, in one embodiment an airborne or other system such as satellite 112 is used to sense or acquire plant temperatures (e.g. temperature data) and/or warm plants 20. Heating system 90, which may include antenna 94 and microwave source 92, may be located on satellite 112. Sensor 50 and control system 70 may additionally be located on satellite 112. As shown in FIGS. 2, 5, and 6, plant area 22 may be divided into zones 24 containing portions of the plurality of plants 20. By warming entire zone 24, multiple plants 20 may be warmed at the same time. Alternatively, entire planting area 22 or individual plant 20 may be warmed instead of dividing planting area 22 into zones 24.

Referring to FIG. 7, in one embodiment, plant warming system 30 is provided on mobile device 114 (e.g., a mobile vehicle). Plant warming system 30, which may include antenna 94, may be located on a platform on mobile device 114. Mobile device 114 may be any type of device capable of moving, such as a vehicle, truck, tractor, planting device, mobile sprinkler or watering device, mobile platform, airplane, etc. Mobile device 114 may be configured to be automatically or manually moved about planting area 22. Plant warming system may specify a route for mobile device 114 based on a heating order or prioritized heating plan for the plants within planting area 22. Heating system 90, as well as sensor 50 and control system 70, may be located on mobile device 114. Alternatively, sensor 50 may be positioned or located in the ground, as shown in FIG. 2. As discussed previously, heating system 90, sensor 50, and control system 70 may be separately located (e.g., such that sensor 50 is located with plants 20).

Referring to FIG. 8, method 200 of warming plants is shown. A plant warming system receives the temperature data indicating the temperature of a plant, a zone, or a plant area (202). The temperature data may be acquired by a sensor and the temperature data may be sent to a control system, as discussed previously. The plant warming system may then compare the temperature to a target or desired temperature (204). If the temperature data is less than the target temperature, the plant warming system directs microwaves toward the plant according to temperature difference and needs of the plant (206). If the temperature data is more than the target temperature, the plant warming system moves to a different plant or zone to acquire new temperature data (208). The plant warming system may optionally receive temperature data from a plurality of plants and selectively warm a portion of the plants within the plurality of plants as needed, according to the temperature data.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A plant warming system, comprising:
a sensor configured to acquire temperature data representative of a temperature of a plant;
a heating system including an antenna configured to direct microwaves toward the plant; and
a control system configured to control operation of the heating system based on the temperature data.

2.-7. (canceled)

8. The plant warming system of claim 1, wherein the sensor is located proximate the plant.

9. (canceled)

10. (canceled)

11. The plant warming system of claim 1, wherein the sensor is remote from the plant.

12. (canceled)

13. The plant warming system of claim 1, wherein the sensor is configured to acquire the temperature data using infrared thermometry.

14. The plant warming system of claim 1, wherein the sensor is configured to acquire the temperature data using microwave thermometry.

15. The plant warming system of claim 1, wherein the sensor continuously acquires the temperature data.

16. The plant warming system of claim 1, wherein the sensor acquires the temperature data based on a schedule.

17.-24. (canceled)

25. The plant warming system of claim 1, wherein the control system controls operation of the heating system to direct microwaves toward a specified part of the plant.

26. The plant warming system of claim 1, wherein the plant is one of a plurality of plants in a planting area.

27. The plant warming system of claim 26, wherein the control system prioritizes warming of a first plant over warming of a second plant.

28. (canceled)

29. The plant warming system of claim 27, wherein the expected economic gain of the first plant is greater than that of the second plant.

30. (canceled)

31. The plant warming system of claim 27, wherein the expected energy expenditure for warming of the first plant is less than that of the second plant.

32.-34. (canceled)

35. The plant warming system of claim 1, wherein the sensor is configured to acquire temperature data for a plurality of plants in a particular order according to selected criteria.

36. (canceled)

37. (canceled)

38. The plant warming system of claim 35, wherein the criteria include an optimization between a potential yield of the plurality of plants and the location of individual plants with respect to the antenna.

39. The plant warming system of claim 1, wherein the antenna is moveable to direct the microwaves.

40. The plant warming system of claim 1, wherein the antenna electronically directs the microwaves.

41.-51. (canceled)

52. A system for controlling the temperature of plants, comprising:
a control circuit configured to:
receive temperature data representative of a plurality of plants; and
control operation of an antenna to selectively direct heat energy toward a portion of the plurality of plants based on the temperature data.

53. (canceled)

54. The system of claim 52, wherein the temperature data is acquired by a sensor.

55. (canceled)

56. The system of claim 54, wherein the sensor includes a plurality of sensors.

57. The system of claim 54, wherein the sensor is located adjacent the plurality of plants.

58.-64. (canceled)

65. The system of claim 52, wherein the control circuit controls operation of the antenna based on a selected target temperature.

66. The system of claim 65, wherein the control circuit controls operation of the antenna based on a temperature difference between a representative temperature of the portion of the plurality of plants and the selected target temperature.

67.-77. (canceled)

78. The system of claim 52, wherein the control circuit controls operation of the antenna based on an open loop program.

79.-98. (canceled)

99. The system of claim 52, wherein the frequency of waves providing the heat energy is based on a degree of water absorptivity of the plurality of plants.

100. The system of claim 52, wherein the heat energy is in the form of microwaves.

101. A method of warming a plurality of plants, comprising:
receiving temperature data representative of the plurality of plants;
directing microwaves toward a portion of the plurality of plants based on the temperature data.

102. (canceled)

103. The method of claim 101, further comprising acquiring the temperature data using a sensor.

104.-109. (canceled)

110. The method of claim 103, further comprising using infrared thermometry to acquire the temperature data.

111. The method of claim 103, further comprising using microwave thermometry to acquire the temperature data.

112. (canceled)

113. (canceled)

114. The method of claim 101, further comprising directing the microwaves toward the portion of the plurality of plants based on a selected target temperature.

115. The method of claim 114, further comprising directing microwaves based on a temperature difference between a representative temperature of the portion of the plurality of plants and the selected target temperature.

116.-119. (canceled)

120. The method of claim 115, further comprising basing an intensity of the microwaves on the temperature difference.

121.-136. (canceled)

137. The method of claim 101, further comprising emitting microwaves from an antenna.

138. The method of claim 137, further comprising moving the antenna to direct the microwaves.

139. The method of claim 137, further comprising electronically steering the microwaves.

140.-198. (canceled)
